(19) United States
(12) Patent Application Publication
(10) Pub. No.: US 2012/0318732 A1
(43) Pub. Date: Dec. 20, 2012

(54) SINTERED ETHYLENE POLYMER FILTER

(75) Inventors: Futoshi FUJIMURA, Ichihara-shi (JP); Kazuto Sugiyama, Ichihara-shi (JP); Kotaro Suzuki, Yokohama-shi (JP)

(73) Assignee: MITSUI CHEMICALS, INC., Minato-ku (JP)

(21) Appl. No.: 13/528,320

(22) Filed: Jun. 20, 2012

Related U.S. Application Data
(60) Provisional application No. 61/498,865, filed on Jun. 20, 2011.

(30) Foreign Application Priority Data
Jun. 20, 2011 (JP) 2011-135985

(51) Int. Cl. B01D 39/16

(52) U.S. Cl. 210/506; 210/510.1; 55/523

(57) ABSTRACT

The invention provides a sintered ethylene polymer filter that is free from molding unevenness or defects and has ultrafine and uniform filter pore diameters. An ethylene polymer composition including an ethylene polymer with a specific shape and specific properties and an antistatic agent with a specific form is used as a material for a sintered filter. According to such a composition, the ethylene polymer particles achieve enhanced fluidity when being placed into a sintering mold. Thus, the composition gives a sintered filter that has an ultrafine pore diameter and a narrow pore diameter distribution and is free from molding unevenness or defects.

### TECHNICAL FIELD

The present invention relates to a sintered filter produced by sintering an ethylene polymer composition. In more detail, the invention relates to a filter that is obtained by sintering an ethylene polymer composition and is used to separate or filter fine dust particles from a gas or a liquid.

### BACKGROUND ART

Sintered molded products formed of olefin polymer particles have been heretofore used as filters for separating fine particles from a fluid such as a gas or a liquid. The recent sophisticated demands for filter performance have led to an increasing need for the filter pore diameter to be finer and be controlled with high accuracy.

With regard to such needs, Patent Literature 1 discloses a sintered plastic filter for separating dust particles from a gaseous or liquid medium which includes a permeable porous substrate that is obtained by sintering in a mold an ultrahigh molecular weight ethylenic polyolefin resin in the form of botryoidally-shaped resin particles, and a fine particulate filler that is finer than the polyolefin resin forming the porous substrate and is attached to the pores on the front side of the porous substrate.

However, the permeable porous substrate proposed in Patent Literature 1 is nonuniform in terms of filter pore diameters because of the botryoidal shape of the resin particles that are sintered in a mold. Thus, this permeable porous substrate alone is not suited for accurate filtration.

Patent Literature 2 discloses ultrahigh molecular weight polyolefin fine particles that include not less than 90% by mass of particles having an average particle diameter of not more than 20 μm and ranging in terms of particle diameters from 0 to 40 μm, and a sintered filter produced by sintering the particles in a mold.

However, the ultrahigh molecular weight polyolefin fine particles described in Patent Literature 2 exhibit very poor fluidity due to their ultrafine particulate shape which causes the fluidity to be strongly affected by the electrical charge of such particles. It is therefore expected that defects inevitably occur when the particles are placed into a mold for sintered filter production. The resultant filter obtained by sintering in a mold in the presence of such defects will inevitably have internal defects, thus causing a serious problem in filter performance.

### CITATION LIST

### Patent Literatures

[Patent Literature 1] JP-A-H08-150663

[Patent Literature 2] WO 2009/011231

### SUMMARY OF INVENTION

### Technical Problem

In view of the background art described above, an object of the present invention is to provide a sintered filter that is free from molding unevenness or defects caused by the electrical charging of an ethylene polymer and has ultrafine and uniform filter pore diameters.

### Solution to Problem

The present inventors carried out studies directed toward achieving the above object. The present inventors have then found that the above object is achieved by a sintered filter that is obtained by sintering an ethylene polymer composition including an ethylene polymer with a specific shape and specific properties and an antistatic agent with a specific form. The present invention has been completed based on the finding.

The present invention is concerned with the following [1] to [4].

[1] A sintered filter that is produced by sintering an ethylene polymer composition including

(A) an ethylene polymer satisfying the requirements (i) to (iii) described below, and

(B) an antistatic agent having an average particle diameter of not more than 0.2 μm, the sintered filter having not more than 1 pore or interstice which is 100 μm or more in size within a 1 mm×1 mm cross section,

(i) the average particle diameter is not less than 3 μm and not more than 20 μm,

(ii) the aspect ratio is not less than 1.0 and not more than 1.2,

(iii) the intrinsic viscosity [η] is not less than 5 dl/g and not more than 50 dl/g.

[2] The sintered filter described in [1], wherein the ethylene polymer further satisfies the following requirements (iv) and (v):

(iv) not less than 95% by weight of the ethylene polymer is passed through a mesh sieve having an aperture of 37 μm,

(v) the proportion of particles with an average particle diameter of not more than 1 μm is not more than 5% by weight.

[3] The sintered filter described in [1] or [2], wherein the ethylene polymer composition contains the antistatic agent in an amount of 0.01 to 20 parts by weight with respect to 100 parts by weight of the ethylene polymer.

[4] The sintered filter described in any one of [1] to [3], wherein the ethylene polymer composition is obtained by impregnating the ethylene polymer with the antistatic agent in a liquid state.

### Advantageous Effects of Invention

The ethylene polymer composition according to the invention which includes an ethylene polymer with a specific shape and specific properties and an antistatic agent with a specific form exhibits improved fluidity when powder of the composition is placed into a mold for sintered filter production. As a result, the composition can give a sintered filter that achieves an ultrafine pore diameter and a narrow pore diameter distribution and is free from molding unevenness or defects.

### DESCRIPTION OF EMBODIMENTS

Hereinbelow, components for forming a sintered filter of the invention, as well as a sintered filter formed of such components will be described in detail.

### [Ethylene Polymer (A)]

In the present invention, the term “polymerization” may refer to copolymerization, and the term “polymer” may refer to copolymer. An ethylene polymer having an intrinsic viscosity [η] of 5 dl/g or more will be sometimes referred to as ultrahigh molecular weight ethylene polymer.

An ethylene polymer that is a component in the present invention satisfies the following requirements (i) to (iii). Preferably, the ethylene polymer further satisfies the following conditions (iv) and (v) at the same time.

(i) The average particle diameter is not less than 3 μm and not more than 20 μm.

(ii) The aspect ratio is not less than 1.0 and not more than 1.2.

(iii) The intrinsic viscosity [η] is not less than 5 dl/g and not more than 50 dl/g.

(iv) Not less than 95% by weight of the ethylene polymer is passed through a mesh sieve having an aperture of 37 μm.

(v) The proportion of particles with an average particle diameter of not more than 1 μm is not more than 5% by weight.

Each of these requirements will be described below.

### (i) Average Particle Diameter

Here, the average particle diameter is a median diameter (D50) measured by a Coulter counter method. The average particle diameter is in the range of 3 μm to 20 μm. The lower limit of the average particle diameter is preferably 3 μm, more preferably 4 μm, and still more preferably 5 μm. The upper limit of the average particle diameter is preferably 20 μm, more preferably 15 μm, and still more preferably 10 μm.

This average particle diameter of the ethylene polymer ensures that the particles of the ethylene polymer are placed in contact with one another with small gaps, and a sintered filter produced using the ethylene polymer achieves a fine pore diameter.

### (ii) Aspect Ratio

The aspect ratio is determined by image analysis with respect to the ethylene polymer particles. The aspect ratio represents a width to length ratio of a minimum rectangle which encircles a projected shape of a particle (a circumscribed rectangle). The closer to 1 the ratio, the closer to a circle the shape of the projected image of the particle, indicating that the particle is closer to a sphere. The aspect ratio is not less than 1.0 and not more than 1.2.

As apparent from the above definition of the aspect ratio, the lower limit of the aspect ratio is 1.0. Because an aspect ratio of 1.0 represents the most preferred particle shape, there is no point in fixing the lower limit value. If the lower limit is to be fixed, however, the lower limit will be 1.1, preferably 1.05, and more preferably 1.0. The upper limit is preferably 1.2, more preferably 1.15, and still more preferably 1.1.

This aspect ratio of the ethylene polymer ensures that the ethylene polymer particles can be closely packed. The satisfaction of this requirement, in combination with the satisfaction of the above average particle diameter and the proportion of large particles, ensure that a sintered filter obtained using the ethylene polymer achieves a fine pore diameter.

### (iii) Intrinsic Viscosity [η]

The intrinsic viscosity [η] is a value measured at 135° C. in a decalin solvent. The intrinsic viscosity [η] is in the range of 5 dl/g to 50 dl/g, preferably 10 dl/g to 40 dl/g, more preferably 10 dl/g to 30 dl/g.

This intrinsic viscosity [η] of the ethylene polymer ensures that a sintered filter obtained using the ethylene polymer exhibits excellent impact resistance, wear resistance and strength.

### (iv) Proportion of Particles Passed Through Mesh Sieve with Aperture of 37 μm

The proportion of particles passed through a mesh sieve with an aperture of 37 μm is obtained by subjecting the ethylene polymer to sieving through a vibration sieve or an ultrasonic vibration sieve with an aperture of 37 μm, and calculating the weight fraction of the particles that have been passed through the sieve. The proportion is preferably not less than 95% by weight, more preferably not less than 98% by weight, still more preferably not less than 99.7% by weight, and most preferably 100%. That is, the phrase not less than 95% by weight of the ethylene polymer is passed through a 37 μm aperture mesh sieve means that the proportion of large particles is low. By using such an ethylene polymer in the production of a sintered filter, the obtainable sintered filter has a high uniformity and a uniform pore diameter.

If the particles passed through a 37 μm aperture mesh sieve represent a lower proportion than the above range, the ethylene polymer particles include a large proportion of coarse particles. The use of such an ethylene polymer in the production of a sintered filter can result in a decrease in the uniformity of the molded article, for example, nonuniform pore diameters or structural defects of the sintered filter.

The proportion of particles passed through a 37 μm aperture mesh sieve may be controlled to be within the aforementioned range by, for example, adjusting the reaction conditions or the type of a polymerization catalyst used in the stage of producing the ethylene polymer (the polymerization stage). Alternatively, it is possible to use only the particles that have been passed through a 37 μm aperture mesh sieve in the above-described manner individually.

### (v) Proportion of Particles with Average Particle Diameter of Not More than 1 μm

The proportion of particles with an average particle diameter of not more than 1 μm may be calculated from the results of the analysis of the particle size distribution by a Coulter counter method described above. The proportion is not more than 5% by weight, preferably not more than 3% by weight, and more preferably not more than 1% by weight of the entirety of the ethylene polymer. There is no particular lower limit of the proportion because the absence of such particles is most preferable.

Such fine particles with an average particle diameter of not more than 1 μm easily find their way into the spaces formed by the sintered particles of the ethylene polymer satisfying the requirements (i) to (iii). That is, such fine particles can cause clogging of the pores of the sintered filter, thereby lowering the filtration performance of the filter.

The proportion of particles having an average particle diameter of not more than 1 μm may be controlled to be within the aforementioned range by, for example, adjusting the reaction conditions or the type of a polymerization catalyst used in the stage of producing the ethylene polymer (the polymerization stage). Alternatively, the ethylene polymer particles may be sieved through a 1 μm aperture mesh sieve, and only the particles remaining on the sieve may be used.

The ethylene polymer, which is a component in the present invention, may be an ethylene homopolymer or an ethylene-based crystalline copolymer obtained by copolymerizing ethylene with a small amount of an α-olefin having 3 or more carbon atoms such as propylene, 1-butene, 4-methyl-l-pentene, 1-pentene, 1-hexene, 1-octene or 1-decene. From the viewpoints of impact resistance, wear resistance and strength, an ethylene homopolymer is preferable. An ethylene homopolymer may have a branched structure depending on the type of the olefin polymerization catalyst used in the polymerization of ethylene. In the present invention, however, the ethylene polymer particles are preferably free from such branches.

The ethylene polymer particles, which are a component in the invention, may be produced by homopolymerizing ethylene or copolymerizing ethylene and another α-olefin having 3 or more carbon atoms using a known olefin polymerization catalyst. For example, the ethylene polymer particles may be produced by a method described in Patent Literature 2 mentioned in relation to the background art, or by a method described in WO 2006/054696.

The ethylene polymer may be used in combination with any of known stabilizers as required. Examples of such stabilizers include heat stabilizers such as tetrakis [methylene(3,5-di-t-butyl-4-hydroxy)hydrocinnamato]methane and distearyl thiodipropionate; and weathering stabilizers such as bis(2,2′,6,6′-tetramethyl-4-piperidine) sebacate and 2-(2-hydroxy-t-butyl-5-methylphenyl)-5-chlorobenzotriazole. Further, colorants may be added, with examples including inorganic and organic dry colors. Other suitable stabilizers are stearates such as calcium stearate which are known as lubricants or hydrogen chloride absorbers.

[Antistatic Agent (B) with Average Particle Diameter of Not More Than 0.2 μm]

An antistatic agent that is a component in the present invention has an average particle diameter of not more than 0.2 μm according to an image analysis with respect to scanning electron microphotographs of the particles.

As the organic antistatic agents, examples of the antistatic agents for use in the invention include organic antistatic agents such as metallic soaps and surfactants including cationic surfactants, anionic surfactants, amphoteric surfactants and nonionic surfactants; and inorganic antistatic agents such as aluminas, silicas, activated carbons, carbon blacks and metal powders.

Examples of the cationic surfactants include alkylamine salts such as laurylamine acetate and stearylamine acetate, and quaternary ammonium salts such as lauryltrimethyl ammonium chloride.

Examples of the anionic surfactants include alkylbenzenesulfonates, alkylnaphthalenesulfonates, alkanesulfonates, alkylphosphates, polyoxyethylene alkylsulfates and polyoxyethylene alkylphenyl ether sulfates.

Examples of the nonionic surfactants include polyoxyethylene alkyl ethers, polyoxyethylene alkylphenyl ethers, polyoxyethylene fatty acid esters, sorbitan fatty acid esters, polyoxysorbitan fatty acid esters, polyoxyethylene alkylamines, glycerin fatty acid esters and oxyethylene-oxypropylene block copolymers.

Examples of the amphoteric surfactants include phosphate surfactants and lauryl dimethyl amine oxides.

Examples of the metallic soaps include, but are not particularly limited to, metal salts of carboxylic acids having 12 to 30 carbon atoms such as calcium stearate, zinc stearate, magnesium stearate, barium stearate, zinc 12-hydroxystearate, zinc stearyl phosphate, calcium laurate, barium laurate, zinc laurate, calcium ricinoleate, barium ricinoleate and zinc ricinoleate.

The above organic antistatic agents may be in the form of solid with an average particle diameter of not more than 0.2 μm, or may be in the form of liquid. As used herein, the term “liquid form” means that the agent itself is liquid in an environment in which it is used, or the agent is in the form of solution in a solvent. The solvents for dissolving the antistatic agents are not particularly limited as long as the antistatic agent exhibits good solubility. Exemplary solvents are aromatic hydrocarbons such as benzene, toluene and xylene; aliphatic hydrocarbons such as hexane, heptane, octane, nonane and decane; halogenated solvents such as methylene chloride, chloroform and carbon tetrachloride; alcohol solvents such as ethanol, methanol and isopropyl alcohol; phenol solvents such as phenol and cresol; ketone solvents such as acetone and butanone; and water. A mixture of two or more kinds of these solvents may be used.

When the antistatic agent is dissolved in the solvent, the upper limit of the concentration of the antistatic agent solution is 100 mmol/L, preferably 1 mmol/L, and more preferably 0.1 mmol/L, and the lower limit of the concentration is 0.01 mmol/L, preferably 0.015 mmol/L, and more preferably 0.02 mmol/L.

Any concentration of the antistatic agent solution exceeding the above range is not preferable because when the solvent is removed after the ethylene polymer and the antistatic agent are brought into contact with each other in the production of an ethylene polymer composition described later, the precipitation of the antistatic agent proceeds so rapidly that the particles of the antistatic agent precipitated on the ethylene polymer become coarse. The use of such an ethylene polymer composition is likely to result in a sintered filter having defects.

Any concentration of the antistatic agent solution that is less than the above range is not preferable because such a thin solution of the antistatic agent does not allow the antistatic agent to be precipitated in a sufficient amount onto the ethylene polymer and consequently the antistatic agent fails to sufficiently suppress the ethylene polymer particles from becoming electrically charged. Another reason why the use of such a thin solution is not preferable is because production costs are raised if the concentration is lowered by increasing the amount of the solvent used.

Of the organic antistatic agents, those in the form of liquid are considered to be free of the idea of average particle diameter. In such cases, the average particle diameter for a liquid antistatic agent is defined to correspond to the molecular size of the antistatic agent molecule.

As described hereinabove, examples of the inorganic antistatic agents include aluminas, silicas, activated carbons, carbon blacks and metal powders. When any of these inorganic antistatic agents is used as a component in the present invention, it is necessary that the average particle diameter thereof is not more than 0.2 μm. If the average particle diameter is in excess of 0.2 μm, the antistatic agent cannot be applied uniformly to the ethylene polymer so as to fail to provide a desired antistatic effect. Further, the presence of such large antistatic agent particles can cause the occurrence of defects in the obtainable sintered filter.

The average particle diameter of the inorganic antistatic agent may be controlled to be not more than 0.2 μm by any known crushing method without limitation.

The antistatic agents may be used individually, or two or more kinds may be used in combination.

Of the antistatic agents mentioned above, the metallic soap antistatic agents are preferable, and calcium stearate is more preferable in order to suppress the ethylene polymer from becoming electrically charged as well as to achieve the advantageous effects of the invention, namely, to enhance the fluidity of the particles when the particles are placed into a mold for sintered filter production and to obtain a sintered filter which has an ultrafine pore diameter and a narrow pore diameter distribution and is free from molding unevenness or defects. From the viewpoint of the durability of the advantageous effects, it is a preferred embodiment to use the antistatic agent in the form of liquid, and more preferably in the form of solution in the solvent.

### [Ethylene Polymer Composition]

An ethylene polymer composition that is used as the material for a sintered filter according to the present invention is obtained from the ethylene polymer (A) and the antistatic agent (B) having an average particle diameter of not more than 0.2 μm as essential components.

The ethylene polymer composition contains the antistatic agent in an amount of, with respect to 100 parts by weight of the ethylene polymer, 0.01 to 20 parts by weight, preferably 0.05 to 15 parts by weight, and more preferably 0.1 to 10 parts by weight.

If the content of the antistatic agent exceeds the above range, the particles of the antistatic agent become aggregated on the ethylene polymer, thus causing the occurrence of filter defects in the production of a sintered filter. If the content is less than the above range, the antistatic agent cannot sufficiently suppress the ethylene polymer particles from becoming electrically charged. Such an ethylene polymer composition exhibits poor fluidity so as to fail to fill a mold appropriately and tends to forma sintered filter having molding unevenness or defects as well as enlarged pore diameters.

In the ethylene polymer composition, the antistatic agent is present on the ethylene polymer, and the particle diameter of the antistatic agent is not less than 0.01 μm and not more than 0.2 μm. The lower limit of the particle diameter is preferably 0.01 μm, more preferably 0.015 μm, and still more preferably 0.02 μm. The upper limit is preferably 0.2 μm, more preferably 0.15 μm, and still more preferably 0.1 μm. The phrase “on the ethylene polymer” comprehends both on the surface and in the inside of the ethylene polymer particles.

In the case where the antistatic agent is an inorganic antistatic agent, or is an organic antistatic agent and is used in the form of solid, the particle diameter of the antistatic agent present on the ethylene polymer is assumed to be substantially the same as the particle diameter of the antistatic agent. In the case where the antistatic agent is an organic antistatic agent and has been dissolved in the solvent, the term “particle diameter” corresponds to the diameter of solid particles which result from the precipitation of the antistatic agent onto the ethylene polymer.

The particle diameter of the antistatic agent is considered to have a close relationship with the aforementioned content of the antistatic agent. Any particle diameters of the antistatic agent exceeding the aforementioned range are not preferable because such large particles can cause defects in the production of a sintered filter. Any particle diameters of the antistatic agent smaller than the aforementioned range are not preferable because such small particles can not sufficiently suppress the ethylene polymer particles from becoming electrically charged.

The ethylene polymer composition contains the ethylene polymer (A) and the antistatic agent (B) with an average particle diameter of not more than 0.2 μm. These two components may be brought into contact with each other by any of common methods without limitation. For example, in the case where the antistatic agent is an inorganic antistatic agent, or is an organic antistatic agent and is used in the form of solid, the antistatic agent may be directly added to the ethylene polymer or may be mixed and kneaded together with the ethylene polymer. In the case where the antistatic agent is an organic antistatic agent in the form of liquid, the ethylene polymer may be impregnated with the liquid antistatic agent or the solution thereof. In the present invention, an impregnation method is more preferably used because the ethylene polymer and the antistatic agent can be brought into homogeneous contact with each other.

In the case where a solution of the antistatic agent in the solvent is used, the solvent may be removed by any of common methods without limitation after the ethylene polymer and the antistatic agent are brought into contact with each other. Exemplary methods are filtration, and evaporating the solvent at ordinary temperature or around the boiling point of the solvent. The solvent may be evaporated at normal pressure or under reduced pressure.

### [Sintered Filters]

A sintered filter according to the present invention is obtained by sintering the aforementioned ethylene polymer composition. Because the polymer composition has a very high molecular weight, a high sphericity and a uniform particle diameter, it can give a porous sintered filter which has a small pore diameter, namely, a small pore size, and is uniform in terms of pore diameters, namely, has a narrow pore diameter distribution. The sintered filter may be favorably used as a filter for filtering industrial water, and a filter for filtering drinking water, juice, wine and alcohol.

The average pore diameter of the sintered filter obtained according to the invention varies in accordance with the average particle diameter of the ethylene polymer particles used. Appropriate pore diameters may be selected in accordance with an application. However, it is preferable that the pore diameters be uniform. In view of the average particle diameter (not less than 3 μm and not more than 20 μm) of the ethylene polymer that is a component in the invention, the pore diameters of obtainable filters are expected to be about not less than 0.6 μm and not more than 4 μm.

As an indicator of how few structural defects are present in the inventive sintered filter, the sintered filter has not more than 1 pore or interstice which is 100 μm or more in size within a 1 mm×1 mm cross section.

The pore diameter of the sintered filter, as well as the number of pores or interstices which are 100 μm or more in size may be measured by, for example, using a scanning electron microscope.

The sintered filter according to the present invention is obtainable by packing the ethylene polymer composition described above into a mold having a predetermined size by vibration compaction, and sintering the composition at a temperature of 140 to 230° C. for 1 to 60 minutes. The temperature range and the heating time is appropriately controlled according to an intrinsic viscosity [η] and an average particle diameter of the ethylene polymer contained in the ethylene polymer composition used.

### EXAMPLES

The present invention will be described in detail by presenting examples hereinbelow without limiting the scope of the invention. Properties were measured by the following methods.

(Measurement of Average Particle Diameter (Median Diameter (D50)) and Proportion of Particles with Average Particle Diameter of Not More Than 1 μm)

The average particle diameter (the median diameter (D50)) and the proportion of particles with an average particle diameter of not more than 1 μm were measured with Coulter Counter Multisizer II manufactured by Beckman Coulter, Inc.

(Proportion of Particles Passed through 37 μm Aperture Mesh Sieve)

The proportion of particles passed through a mesh sieve with an aperture of 37 μm was determined by calculating the weight fraction of particles that had been passed through a 37 μm aperture mesh sieve (Tyler No. 400).

### (Measurement of Aspect Ratio)

The aspect ratio was determined by image analysis using particle size and shape distribution analyzer PITA-2 manufactured by SEISHIN ENTERPRISE CO., LTD.

### (Measurement of Intrinsic Viscosity [η])

The ethylene polymer was dissolved in decalin and the intrinsic viscosity [η] was measured with respect to the solution at 135° C.

### (Molding of Sintered Filter)

The ethylene polymer composition was packed into a mold (size: thickness 2 mm, width 100 mm, height 100 mm) by vibration compaction, and was sintered in the mold at a temperature of 140° C. for 60 minutes, thus forming a sintered filter.

### Example 1

An ethylene polymer was provided which had an intrinsic viscosity [η] of 14 dl/g, an average particle diameter of 10 μm and an aspect ratio of 1.1 and contained 95% by weight of particles passed through a 37 μm aperture mesh sieve and 0.5% by weight of particles with an average particle diameter of not more than 1 μm. 100 Parts by weight of the ethylene polymer was added to a solution of 1 part by weight of calcium stearate (particle diameter 30 μm) in toluene (6.6 mmol/L). Toluene was evaporated at normal temperature and under reduced pressure. Thus, an ethylene polymer composition was prepared.

The ethylene polymer composition was sintered by the aforementioned method. A 1 mm×1 mm cross section of the resultant sintered filter was observed with a scanning electron microscope (model: JSM-6510LV manufactured by JEOL Ltd.). No pores or interstices which were 100 μm or more in size were found.

### Comparative Example 1

A sintered filter was obtained by sintering the ethylene polymer used in Example 1 alone (without bringing it into contact with the toluene solution of calcium stearate) in a similar mold under the same conditions as in Example 1. A 1 mm×1 mm cross section of the sintered filter was observed with the scanning electron microscope. Three pores or interstices which were 100 μm or more in size were found.

### Comparative Example 2

A sintered filter was obtained by sintering in a mold under the same conditions as in Example 1, except that 1 part by weight of calcium stearate (particle diameter 30 μm) was blended with 100 parts by weight of the ethylene polymer without being dissolved in toluene. A 1 mm×1 mm cross section of the sintered filter was observed with the scanning electron microscope. Two pores or interstices which were 100 μm or more in size were found.

### INDUSTRIAL APPLICABILITY

The sintered filter according to the invention is a porous sintered filter which has a small pore diameter, namely, a small pore size, and is uniform in terms of pore diameters, namely, has a narrow pore diameter distribution. Thus, the sintered filter may be favorably used as a filter for filtering industrial water, and a filter for filtering drinking water, juice, wine and alcohol.

1. A sintered filter that is produced by sintering an ethylene polymer composition comprising
(A) an ethylene polymer satisfying the following requirements (i) to (iii), and
(B) an antistatic agent having an average particle diameter of not more than 0.2 μm,
the sintered filter having not more than 1 pore or interstice which is 100 μm or more in size within a 1 mm×1 mm cross section,
(i) the average particle diameter is not less than 3 μm and not more than 20 μm,
(ii) the aspect ratio is not less than 1.0 and not more than 1.2,
(iii) the intrinsic viscosity [η] is not less than 5 dl/g and not more than 50 dl/g.

2. The sintered filter according to claim 1, wherein the ethylene polymer further satisfies the following requirements (iv) and (v):
(iv) not less than 95% by weight of the ethylene polymer is passed through a mesh sieve having an aperture of 37 μm,
(v) the proportion of particles with an average particle diameter of not more than 1 μm is not more than 5% by weight.

3. The sintered filter according to claim 1, wherein the ethylene polymer composition contains the antistatic agent in an amount of 0.01 to 20 parts by weight with respect to 100 parts by weight of the ethylene polymer.

4. The sintered filter according to claim 1, wherein the ethylene polymer composition is obtained by impregnating the ethylene polymer with the antistatic agent in a liquid state.
